(19) United States
(12) Patent Application Publication
(10) Pub. No.: US 2004/0115034 A1
(43) Pub. Date: Jun. 17, 2004

(54) Apparatus and method for loading and unloading aircraft cargo

(76) Inventors: Seppo Arijoki, Butzbach (DE); Fred Horner, Wertheim (DE); Gottfried Reymann, Wiesbaden (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/700,874

(22) Filed: Nov. 4, 2003

(30) Foreign Application Priority Data
Nov. 8, 2002 (EP) 02 024 875.3

(51) Int. Cl. B60P 1/02

(52) U.S. Cl. 414/495

(57) ABSTRACT

A method for loading an aircraft comprises receiving a load onto a first loading platform and lifting the load by raising this loading platform, subsequently transferring the load from this loading platform onto a second lowered loading platform, and finally lifting the load by raising this platform so that the load may finally be transferred from the second loading platform into the aircraft hold. The unloading procedure is the reverse of this procedure. An associated mobile aircraft loading device is provided with a vertically displaceable platform to receive the load, as well as hoisting mechanisms for the platform. The upper surface of the loading platform, in its uppermost position, is coplanar with the load level of an aircraft, and in its lowermost position, is coplanar with the load level of a raised platform of another loading device. Aircrafts with a very high load level may be simply loaded and unloaded using such a procedure.

### BACKGROUND OF THE INVENTION

The invention relates to a method or procedure to load an aircraft, and an associated mobile aircraft apparatus or loading device.

A mobile aircraft loading device is known, for example from DE 37 30 415 C2. It includes a frame, a rear (main) loading platform that is vertically moveable with respect to the frame, and a front loading platform (front platform). Power devices serve for independently raising and lowering the two loading platforms, whereby the upper surface of each loading platform serves to receive the goods being loaded and unloaded.

Each loading platform is supported by a scissor-type mechanism. An additional lift cylinder is provided for the scissor-type mechanism pair of the front loading platform that engages with the yoke to which one leg of the scissor pair is attached. The rear loading platform is raised by two chains that pass over rollers that may be raised and lowered by means of vertically positioned hydraulic cylinders. For this aircraft loading device, the scissor-type mechanisms for each platform have both a load bearing and a guide function. The design principle of the scissor-type mechanisms requires a maximum lift height of the loading platforms that is not adequate for especially large aircrafts with correspondingly higher positioned loading levels. For such an aircraft, the loading level may be as much as 8.0 m or higher above the surface of the apron, or above the aircraft loading device.

In the described aircraft loading device, loading of the aircraft is performed by raising the front loading platform to the load level and leaving it there. The load is shoved onto the lowered rear loading platform and then raised. If the rear loading platform is at the same level as the front loading platform, the load is shoved over the front loading platform into the aircraft. The maximum lifting level of the rear loading platform is thus equal to that of the front loading platform.

Unloading of the aircraft occurs in reverse in that the load is moved out of the aircraft onto the front loading platform located in raised position, and the load is lowered to the rear loading platform.

Similar aircraft loading devices are known from DE 21 30 968 A and U.S. Pat. No. 3,850,283. With these, a transport system consisting of a large number of rollers is integrated into the rear loading platform. It is known from practice to achieve a greater lift height using scissor-type mechanisms without having to increase overall vehicle length. Two or more scissor-type mechanism systems positioned one above the other are used for this. Such a configuration of an aircraft loading device is very complicated and expensive to manufacture, and is also technically problematic, since large loads must be raised and lowered with the rear loading platform at a very low height (about 520 mm) that is dictated by the system.

### SUMMARY OF THE INVENTION

It is the task of the invention to provide a procedure to load and unload an aircraft with a very high load height and to create a device by means of which such a loading procedure may be performed especially simply while maintaining an optimum configuration of the aircraft loading device. The procedure and the device particularly take into account aircraft types in which the loading or unloading of a particular aircraft occurs at different load levels.

The invention also suggests a procedure to load and unload an aircraft using the following steps:

a. Reception of load onto a first loading platform,

b. Lifting the load by raising the first loading platform,

c. Transferring the load from the first loading platform onto a second lowered loading platform,

d. Lifting the load by raising the second loading platform, and

e. Transferring the load from the second loading platform into the aircraft hold.

This loading procedure thus provides the ability for the load to be lifted by the first loading platform in the lower range of the lift, while the second loading platform lifts the load in the upper range of the lift. Thus, the lift range of the lower lift coincides with part of that of the upper lift so that the load may be transferred to the second loading platform from the first loading platform when the latter is in a partially or totally raised position and the former is in a partially or totally lowered position. The maximum lift level of the first loading platform preferably corresponds to the maximum lift level of the main platform and front platform of aircraft loading devices described as state of the art above.

For this, lifting the load from the raised level of the first loading platform is performed by means of the second loading platform by a height that is 50 to 100 percent of the height that the load is lifted using the first loading platform.

If a particularly large aircraft, e.g., a type A380 Airbus aircraft, requires loading, then the lower load level of the aircraft may be accessed with the second loading platform in the lowered position, and the upper load level may be accessed with the second loading platform in the raised position. Further, the load level of a smaller aircraft, such as an Airbus A300, A310, A340 or Boeing 747, may be served by a fully loaded or partially lowered second loading platform. This means, in fact, that the load may be raised using the first loading platform starting at a level near ground level up to about 6.00 m above ground level, and may be raised using the second loading platform between about 4.00 and 8.50 m above ground level.

Unloading of an aircraft that was loaded based on the invention occurs in reverse. Thus, the procedure of unloading an aircraft includes the following characteristics:

a. Transferring of the load from the aircraft hold onto a raised, second loading platform,

b. Lowering the load by lowering the second loading platform,

c. Transferring of the load from the second loading platform onto a raised, first loading platform,

d. Lowering the load by lowering the first loading platform, and

e. Removal of the load from the first loading platform.

The above-mentioned percentages and dimensions regarding the aircraft loading process also apply to unloading the aircraft.

According to a special expansion of the invention, provisions are made so that the load is transferred to the first loading platform of a first aircraft loading device and to the second loading platform of a second aircraft loading device. This involves two different devices by means of which the loading or unloading procedure is performed. This involves independent functions, particularly requiring two vehicles. In the configuration of two aircraft loading devices, particularly two vehicles, the aircraft loading device including the second platform fulfills the function of an adapter between the first aircraft loading device and the aircraft. The first aircraft loading device or the first vehicle is a conventional aircraft loading device based on the state of the art, e.g., the state of the art per DE 37 30 415 C2. In order to bridge the vertical distance between the maximum transport height of the first aircraft loading device and the upper load level of a particularly large aircraft, the second loading platform is provided as an independent, particularly mobile functional unit in its role as adapter. As a result, in order to be able to load and unload a particularly large aircraft, e.g., an Airbus A380, conventional aircraft loading devices may be used, whereby the height distance to the upper load level of the aircraft is bridged using the second aircraft loading device.

As described above, the concept of a loading platform, particularly of a first or second loading platform, must be understood to be widely encompassing. Functional units are involved here. Thus, both the first and the second loading platforms may consist of a main platform and a front platform. Instead of a front platform, a transfer bridge may be provided, especially for the second loading platform. This may, of course, also be provided in addition to the front platform. The load is transferred via the transfer bridge into the aircraft's hold. The transfer bridge is provided in order to be able to react to changes in height of the load level during loading or unloading the aircraft in that it may be raised or lowered, tilted to one side, or the front edge may be tilted up or down. These changes in position take into account movement by the aircraft suspension system and an altered tilt of the load surface of the aircraft during loading or unloading the aircraft.

Further, the invention suggests a mobile aircraft loading device. It includes a loading platform capable of being raised and lowered to receive the load being loaded or unloaded, and means to raise and lower the loading platform, whereby the loading platform while raised forms a level with the aircraft load level, and while lowered, forms a level with the load level of a raised loading platform of another loading device.

The aircraft loading device embodying one aspect of the invention thus represents one of two different aircraft loading devices. The device designated as the loading device need not be a device that is specifically configured as an aircraft loading device. It is sufficient if this aircraft loading device is a simple hoisting device that serves the purpose of transferring a load from a lowered level to a raised level. It is considered advantageous, however, if the other loading device is also configured as an aircraft loading device. In this case, the two aircraft loading devices form independent functional units. This embodiment of the present invention is in the nature of an adapter, and is functional only in combination with the other aircraft loading device, because the load must first be lifted to the lowered exit level of the second aircraft loading device by means of the first aircraft loading device. Since the aircraft loading devices are independent functional units, the first aircraft loading device may be used as a conventional aircraft loading device to load and unload an aircraft with a relatively low load level. Airport operators who must deal with an aircraft with increased load level such as, for example, an aircraft of the type of the Airbus A380, need not maintain apron devices that are designed only for this type of aircraft. It is sufficient to use conventional airport apron devices, i.e., conventional aircraft loading devices, and to bridge the distance height to the high load level of this aircraft with the aircraft loading device based on the invention performing the role of an adapter.

Scissor-type mechanisms to raise the loading platforms of loading and unloading devices are preferably used.

The aircraft loading device embodying one aspect of the present invention includes a frame with a transfer bridge that may be docked to the aircraft that is moveable with respect to this moveable loading platform and with respect to the frame. Further, power devices for independent raising and lowering of the platform and transfer bridge are provided, whereby the upper surface of the platform or of the transfer bridge serves to receive the load being loaded or unloaded. It is particularly intended that the transfer bridge may be raised and lowered using a telescoping mechanism. In order to be able to adapt to the slightly varying positions of the aircraft load level during loading or unloading of the aircraft, it is provided that the transfer bridge may be displaced horizontally, tilted to the side with respect to the horizon, and tilted up or down with respect to the horizon using power mechanisms.

Further characteristics of the invention may be taken from the dependent claims, the Brief Description of the Drawings, and from the figures themselves, whereby it must be mentioned that all individual characteristics and all combinations of individual characteristics represent additional embodiments of the invention.

### BRIEF DESCRIPTION OF THE DRAWINGS

The invention is described schematically using two embodiment examples, but is not thus limited. The figure show:

FIG. 1 The loading procedure for an aircraft using a conventional mobile aircraft loading device and an aircraft loading device based on the invention that is also mobile, performing the function of an adapter between the aircraft loading device and the aircraft in lateral view,

FIG. 2 A view II per FIG. 1 of the aircraft loading device performing the adapter function,

FIG. 3 An aircraft loading procedure using an aircraft loading device based on the invention that includes an aircraft loading device facing the aircraft and a loading device facing away from the aircraft in lateral view,

FIG. 4 A view IV of the aircraft loading device per FIG. 3,

FIG. 5 A configuration of the transfer bridge modified with respect to the embodiment examples in FIGS. 1 through 4 that may be tilted laterally in a view II or IV per FIGS. 2 and 4, and

FIG. 6 A view per FIG. 5, whereby the completely raised position is depicted along with the basically lowered position of the transfer bridge.

### DETAILED DESCRIPTION OF THE PREFERRED EMBODIMENTS

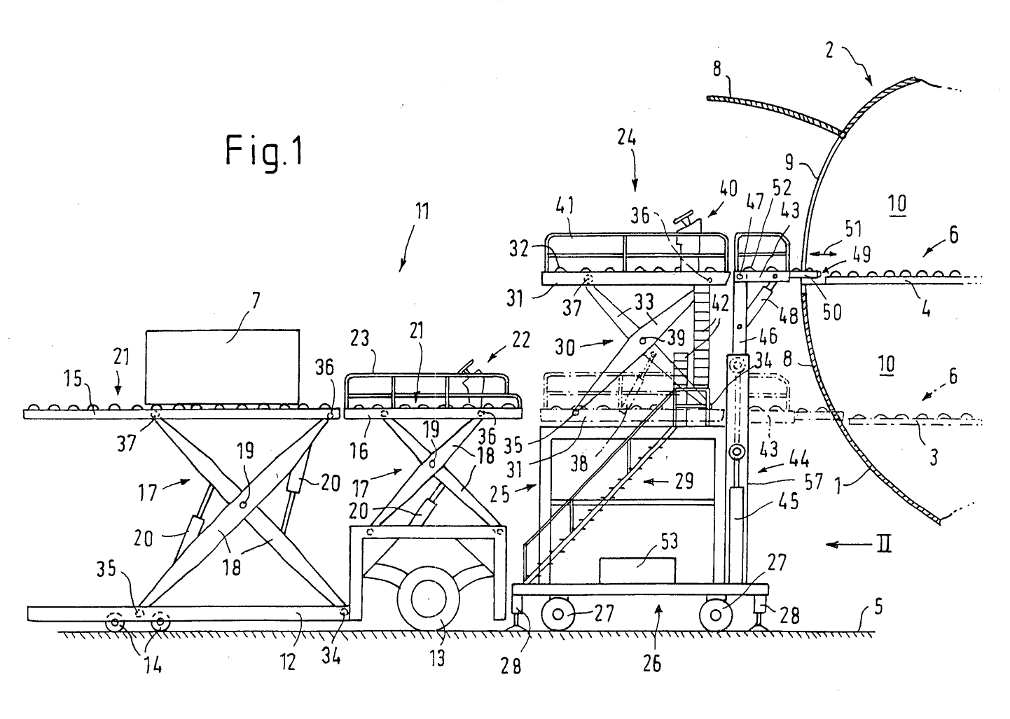

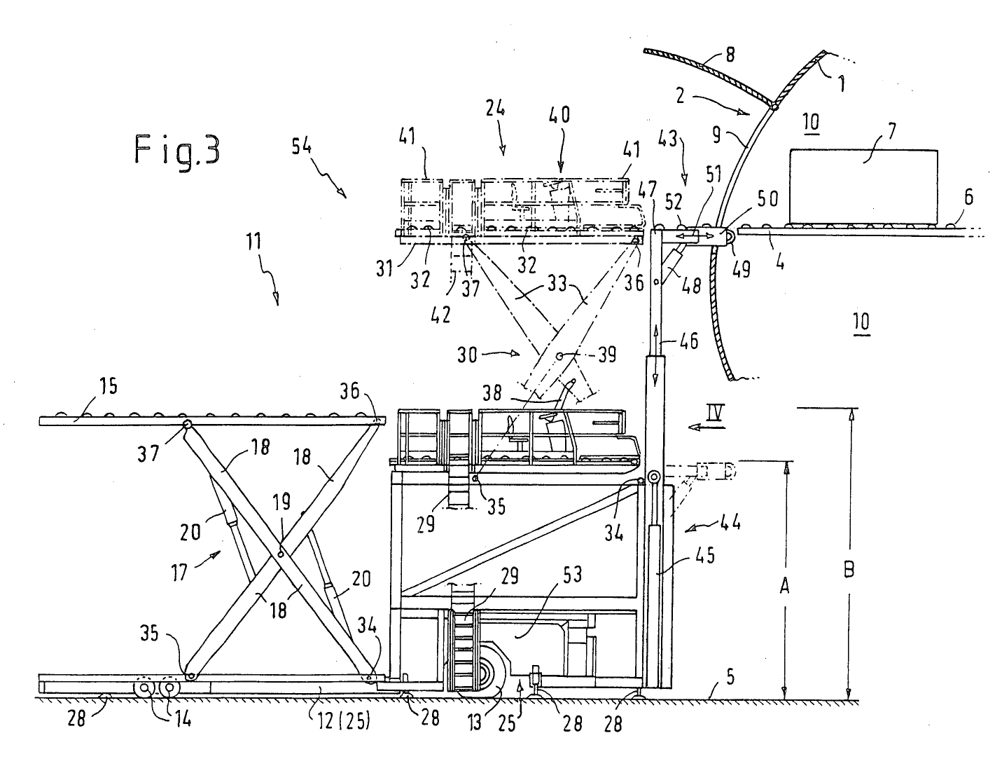

For purposes of description herein, the terms “upper”, “lower”, “right”, “left”, “rear”, “front”, “vertical”, “horizontal” and derivatives thereof shall relate to the invention as oriented in FIGS. 1 and 3. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The fuselage 1 of an aircraft 2 is shown, particularly for an Airbus type A380 aircraft. This aircraft includes a lower load level 3, as well as an upper load level 4 positioned above it. The upper load level is located at a height of about 8.20 m above the ground level 5 of the airport apron. Conveyor systems, implemented as a roller conveyor 6, are positioned at the load levels 3 and 4, by means of which it is possible to transport load nieces, particularly box-shaped containers 7, into the aircraft hold 10 through the loading opening 9 that may be sealed using the hold hatch 8.

A mobile aircraft loading device 11, configured conventionally, now serves for the loading of the cargo or load pieces 7. An aircraft may usually be loaded and unloaded using such an aircraft loading device whose load height is between 4.30 and 5.60 m above ground level 5. Aircrafts of the types Airbus A300, A310, DC10, MD11, or Boeing 747, for example, are involved here.

The aircraft loading device 11 includes a frame 12 that bears a vehicle chassis (not shown) that serves to support steerable front wheels 13 and rear wheels 14. The frame 12 is crimped at right angles, so that it serves to support a larger rear loading platform 15 and a smaller front loading platform 16. Each loading platform 15 or 16 is borne by a scissor-type mechanism pair, whereby the two parts of the scissor-type mechanism connect a yoke (not shown in detail). The rotation axis of the scissor arms 18 is designated by reference index 19. Hydraulic cylinders 20 engage with the yokes connecting the scissor arms 18 that either are borne exclusively within the scissor-type mechanism system (as depicted for the loading platform 15), or between the scissor-type mechanism system and the frame 12, as is shown for the loading platform 16. The hydraulic cylinders 20 serve to raise the loading platforms 15 and 16, and further serve for regulated lowering of these loading platforms. Conveyor systems in the form of roller conveyors are integrated into the loading platforms 15 and 16. Since work is performed on the loading platform 16 of the independent aircraft loading device 11, it is provided with an operator's stand 22 and side rails 23.

FIG. 1 shows box-shaped cargo resting on the roller conveyor 21 of the rear loading platform 15. This involves a conventional box-shaped cargo bin used with aircraft.

FIG. 1 shows the maximally raised position of the loading platforms 15 and 16 for this aircraft loading device, thus forming a load level. In this maximally raised position of the loading platforms 15 and 16, they are located at a level of about 5.60 m above ground level 5, so that an aircraft with the maximum size of a Boeing 747 type aircraft may be loaded using this mobile aircraft loading device 11. At the totally lowered position of loading platforms 15 or 16, these are positioned adjacent to the parallel sections of the fuselage 1. The loading platform 15 is located slightly above ground level 5, and the receiving height of the roller conveyor 21 is actually about 520 mm above ground level 5. The loading platform 16 in its lowered position is thus higher, namely, above the wheel well of the steerable front wheels 13 of the mobile aircraft loading device 11.

The mobile aircraft loading device 24, fulfilling the function of an adapter, is positioned between this aircraft loading device 11 and the aircraft 2. It possesses a raised frame 25 in this supported chassis 26 that serves to support four steerable, powered wheels 27 that are positioned near the corners of the frame. Support elements 28, also positioned at these corners, serve to provide stable support on the ground of the aircraft loading device 24 when the wheels 27 bear no load. A ladder is positioned to the side of the frame 25. The upper horizontal surface of the frame 25 supports a pair of scissor-type mechanism 30 on which a loading platform 31 is supported. This also includes roller conveyors 32 on its upper side. The scissor-type mechanism arms of the scissor-type mechanism 30 are designated by the reference index 33, and the scissor pivot point is designated by the reference index 39. This scissor pair 30 is supported the same as the scissor pair 18 of the aircraft loading device 11 in a frame side fixed end 34, a frame side free end 35, a fixed end 36 toward a loading platform, and a loading platform side free end 37. Two hydraulic cylinders 38 are provided for the loading platform 31 corresponding to the hydraulic cylinders 20 on the loading platform 16 that are supported at one end by the frame 25, and on the other by the yoke 56, such that the scissor arm 33 of the scissor pair 30 in the area between the fixed ends 34 and the scissor pivot point 39 connects adjacent to the pivot point.

The loading platform 31 is provided with an operator stand and an adjacent rail. A ladder 42 that leads to the ladder 29 is provided in order for the operator to be able to enter or leave the raised loading platform 31.

On the side facing the aircraft 2, the aircraft loading device 24 includes a transfer bridge 43 displaceable vertically with respect to the frame 25 that may be docked to the aircraft 2. This serves the purpose of being able to transfer the load 7 distinctly from the loading platform 31 to the load level of the aircraft 2, or from the aircraft 2 onto the aircraft loading device 24. The length of the transfer bridge 43 along the transport direction of the roller conveyors 32 is less than the length of the load along this direction. Basically, an additional unit with a loading platform may be positioned on the frame as is shown for the aircraft loading device 11. This front loading platform could be provided with an overlapping lip.

The above-mentioned transfer bridge 43, based on the actual embodiment example, is supported within a vertical lift device 44, with mobile or telescoping lift components. Raising and lowering the transfer bridge 43 is performed via hydraulic cylinders 45 that engage between the frame 25 and a lift mast of the hoisting device 44. Hydraulic cylinders 48, to displace the transfer bridge 43, engage between the raisable and lowerable lift mast 46 and the transfer bridge 43 pivotable about a horizontal axis 47 within a lift mast 46 so that the transfer bridge 43 may be tilted up or down with respect to the horizon. The front end of the transfer bridge 43 is designated with the reference index 49, and extends slightly into the interior of the aircraft to define a docked position of the aircraft loading device 24 with the end of the roller conveyors 6 facing the aircraft 2.

A lip 50, forming a component of the transfer bridge 43, may be extended or retracted as indicated by the double arrow 51 above other areas (not shown) in the direction of the roller conveyor 6 of the aircraft 2. The transfer bridge 43 is also provided with a roller conveyor 52.

The drive mechanism 53 for the mobile components of the aircraft loading device 24 is supported within the frame 25 adjacent to the chassis 26. This drive mechanism 53 thus provides power for the wheels 27, the supporting elements 28, the hydraulic cylinders 38, 48, and 45, as well as the drive units to extend or tilt the transfer bridge 43.

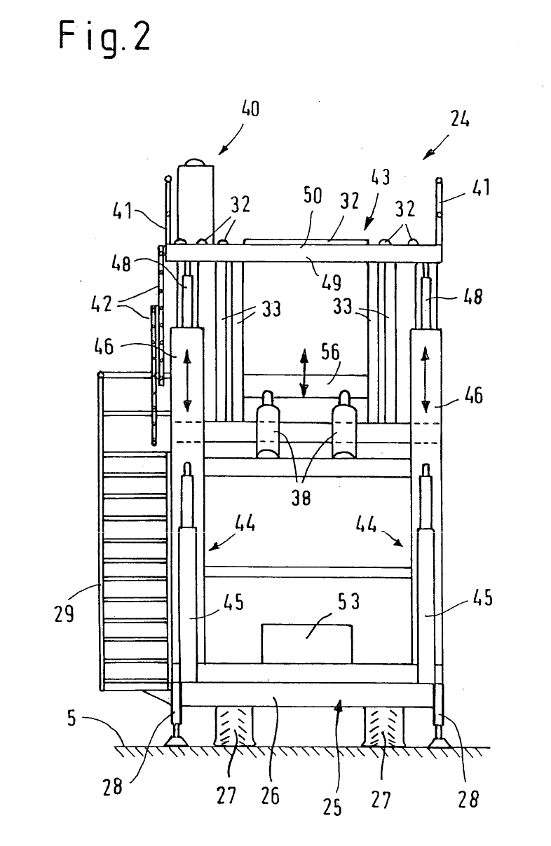

FIGS. 1 and 2 depict the loading platform 31 and the transfer bridge 43 in their uppermost positions. In this case, they serve for the loading or unloading of goods in the area of the upper deck of an aircraft of type Airbus A380, i.e., to a height exceeding 8 meters above ground level. FIG. 1 also depicts the lowered positions of the loading platform 31 and transfer bridge 43. Their roller conveyors 32 and 52 are located at the same level as that of the roller conveyors 21 of the loading platforms 15 and 16. Above this level, the loading process may occur in the vicinity of the lower load level 3 of the aircraft.

The extendable and retractable lip 50 of the transfer bridge 43 allows it to be inserted between the upper load level 4 and the lower load level 3 of the aircraft, and this is taking into account that both the upper load level 4 and the lower load level 3 are above or below that wall area of the aircraft that is located closer to the lift mast 46. This geometrical configuration excludes the possibility that the transfer bridge 43 may be moved directly perpendicular from the upper load level 4 to the lower load level 3 when the end 49 barely extends from the aircraft hold 10. Thus, it is necessary to extend the lip 50 farther.

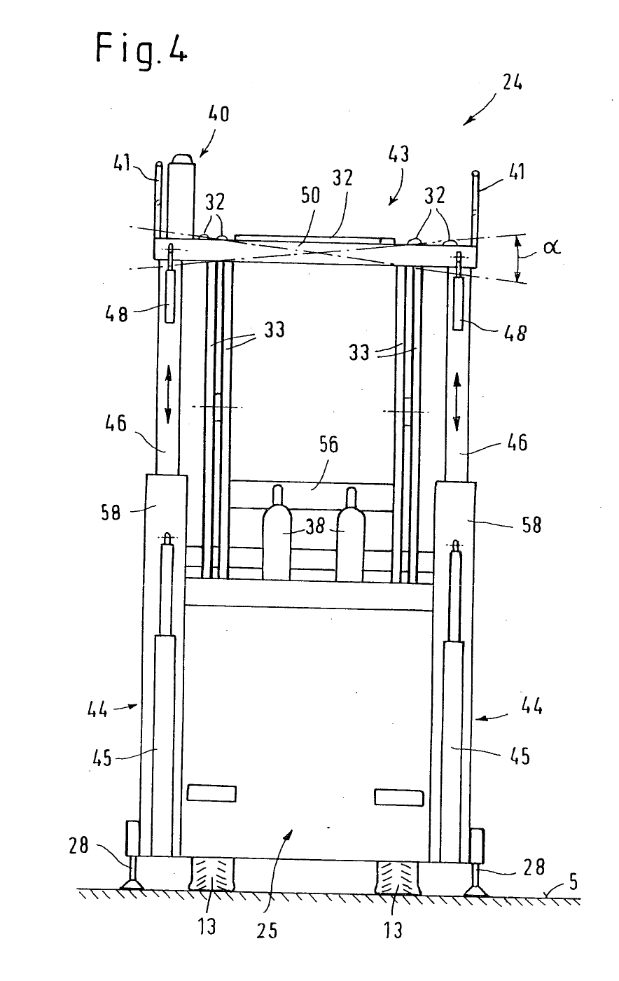

The embodiment example per FIGS. 3 and 4 basically distinguishes itself from that in FIGS. 1 and 2 in that the aircraft loading devices 11 and 24 are integrated into a single vehicle 54. This vehicle does not include a loading platform 16, but rather the loading platform 15 works directly with the loading platform 31. Further, the area assigned to the loading platform 15 that supports the rear wheels is directly connected with the frame 25. In contrast to the embodiment example per FIGS. 1 and 2, this one is modified so that it includes a steerable, powered front axle with wheels 13.

For this embodiment example shown in FIGS. 3 and 4, components with identical functions are labeled using the same indices as those for the embodiment examples in FIGS. 1 and 2. Reference will be made to these embodiment examples regarding design and manner of function of the aircraft loading device.

FIG. 3 depicts the loading platform 31 at its uppermost and lowermost positions. The same applies to the transfer bridge 43. In the uppermost position, loading or unloading of goods 7 located on the upper load level 4 of an Airbus A380 is performed via the loading platform 31 and the transfer bridge 43. Based on the height value “A” in FIG. 3 at the lowermost position, aircraft of the types Airbus A300, A310, DC10, MD11, and a version of the Boeing B747 with low load level, may be loaded and unloaded using loading platform 31 and the transfer bridge 43. The indicated level of the rear loading platform 15, corresponding to the height value “B” in FIG. 3, depicts the load level of a conventional Boeing B747 aircraft. If the loading platform 31 and the transfer bridge 43 are raised to the indicated level of the loading platform 15, this type of aircraft may be loaded and unloaded. The depicted level of the loading platform 15 represents the uppermost position of this loading platform. In the embodiment examples in FIGS. 3 and 4, the hoisting device 44 is supported in the described manner, and the transfer bridge 43 is supported with adjustable length and angle along different axes.

The aircraft 2 is loaded with the goods 7 in that the load is received onto the lowered loading platform 15. The load is subsequently lifted by raising the loading platform 15. Next, the load 7 is also transferred from the loading platform 15, via the loading platform 16, to the loading platform 31. Next, raising the loading platform 31 lifts the load 7. Finally, the load 7 is transferred from the loading platform 31 into the hold 10 of the aircraft 2. Unloading the aircraft is performed by reversing the procedure.

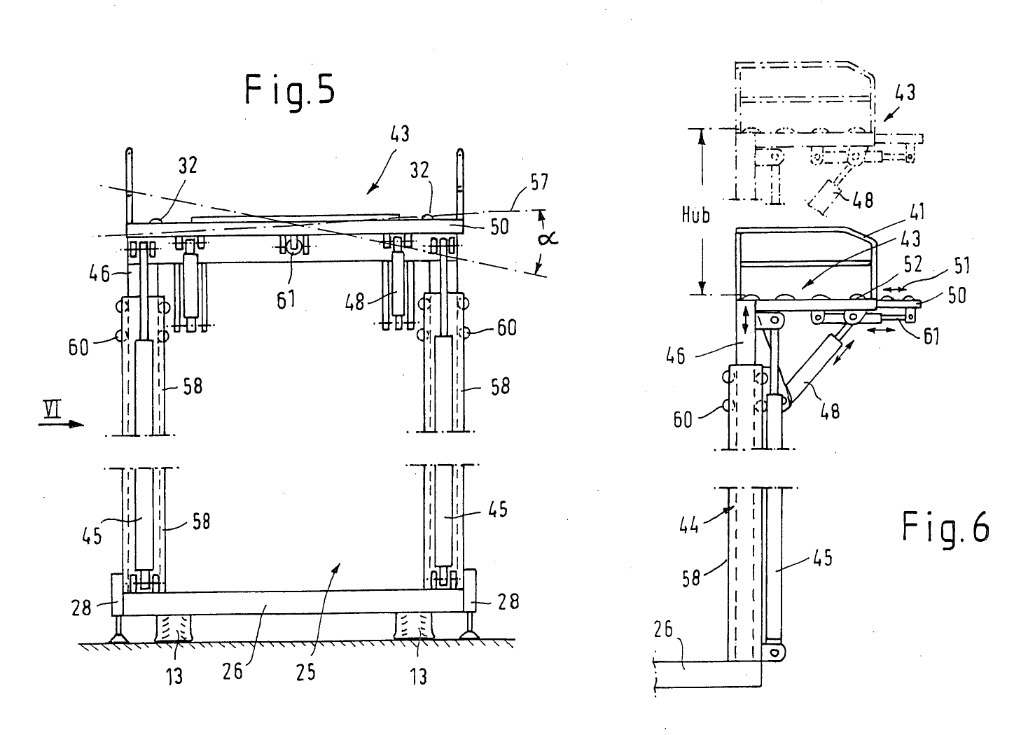

The embodiment examples per FIGS. 5 and 6 depict a version of the aircraft loading device modified with respect to the embodiment examples per FIGS. 1 through 4 in the area of the transfer bridge 43. In this version, the transfer bridge 43 may be tilted up and down relative to the horizon by an angle “α” in either direction, whereby this tilting results from deformation of the transfer bridge 43, including the component of the transfer bridge 43 forming the lip 50.

For the embodiment examples shown in FIGS. 5 and 6, components with identical functions are labeled using the same indices as those for the embodiment examples in FIGS. 1 and 4. Reference will be made to these embodiment examples regarding design and manner of function of the aircraft loading device.

For the embodiment examples shown in FIGS. 5 and 6, the transfer bridge 43 is raised using two cylinders 45 that engage between the frame 25 and the extendable lift mast 46 of the hoisting device 44. The profiled part 58 of the hoisting device 44 connected to the chassis 26 supports the movable lift mast 46 of the hoisting device 44, where rollers 60 act as guides. Tilting of the transfer bridge 43 by the angle “α” in the direction shown in FIG. 5, or in the opposite direction, results from matched loading of the double acting cylinder 48. The lip 50, forming a component of the transfer bridge 43, may be extended or retracted, as shown by the double arrow 51, by means of a double acting cylinder 61.

The invention claimed is as follows:

1. A method for loading an aircraft having a hold disposed at predetermined elevation, comprising the steps of:
providing a first loading platform having a transfer for moving cargo in a generally horizontal direction, and a powered lift to raise and lower the first loading platform between first and second elevations;
positioning a load on the first loading platform at the first elevation;
shifting the first loading platform upwardly to the second elevation to lift the load thereon;
providing a second loading platform having a transfer for moving cargo in a generally horizontal direction, and a powered lift to raise and lower the second loading platform between the second elevation and the predetermined hold elevation above the second elevation;
transferring the load from the first loading platform at the second elevation to the second loading platform at the second elevation;
shifting the second loading platform upwardly from the second elevation to the predetermined hold elevation; and
transferring the load from the second loading platform into the hold of the aircraft.

2. A method as set forth in claim 1, wherein:
said second loading platform shifting step includes raising the second loading platform a distance in the range of 50-100 percent of the distance between the first and second elevations.

3. A method as set forth in claim 2, wherein:
said first loading platform shifting step includes raising the first loading platform from a height adjacent to ground level to a height of around six meters above ground level; and
said second loading platform shifting step includes raising the second loading platform a distance in the range of 4.00-8.50 meters above ground level.

4. A method as set forth in claim 3, wherein:
said first loading platform providing step includes supporting the first loading platform on a first aircraft loading device; and
said second loading platform providing step includes supporting the second loading platform on a second aircraft loading device.

5. A method as set forth in claim 4, including:
providing the first and second aircraft loading devices with separate vehicles.

6. A method as set forth in claim 5, wherein:
said second loading platform transferring step comprises providing a transfer bridge to transfer the load on the second loading platform into the hold of the aircraft.

7. A method as set forth in claim 1, wherein:
said first loading platform shifting step includes raising the first loading platform from a height adjacent to ground level to a height of around six meters above ground level; and
said second loading platform shifting step includes raising the second loading platform a distance in the range of 4.00-8.50 meters.

8. A method as set forth in claim 1, wherein:
said first loading platform providing step includes supporting the first loading platform on a first aircraft loading device; and
said second loading platform providing step includes supporting the second loading platform on a second aircraft loading device.

9. A method as set forth in claim 1, including:
providing the first and second aircraft loading devices with separate vehicles.

10. A method as set forth in claim 1, wherein:
said second loading platform transferring step comprises providing a transfer bridge to transfer the load on the second loading platform into the hold of the aircraft.

11. A method for unloading an aircraft having a hold disposed at predetermined elevation, comprising the steps of:
providing a second loading platform having a transfer for moving cargo in a generally horizontal direction, and a powered lift to raise and lower the second loading platform between the predetermined hold elevation and a second elevation;
positioning a load on the second loading platform at the predetermined hold elevation;
shifting the second loading platform downwardly to the second elevation to lower the load thereon;
providing a first loading platform having a transfer for moving cargo in a generally horizontal direction, and a powered lift to raise and lower the first loading platform between the second elevation and a first elevation below the second elevation;
transferring the load from the second loading platform at the second elevation to the first loading platform at the second elevation;
shifting the first loading platform downwardly from the second elevation to the first elevation; and
removing the load from the first loading platform.

12. A movable aircraft cargo handling apparatus for loading and unloading an aircraft having a predetermined load level, comprising:
a first movable aircraft cargo handling device having a loading platform with a transfer for moving cargo in a generally horizontal direction, and a powered lift to raise and lower the loading platform between an uppermost position disposed substantially coplanar with the load level of an associated aircraft, and a lowermost position disposed substantially coplanar with the load level of a raised loading platform of another loading device.

13. A movable aircraft cargo handling apparatus as set forth in claim 12, including:
a second movable aircraft cargo handling device functionally separate from said first movable aircraft cargo handling device.

14. A movable aircraft cargo handling apparatus as set forth in claim 13, wherein:
said second movable aircraft cargo handling device defines another loading device.

15. A movable aircraft cargo handling apparatus as set forth in claim 14, wherein:
said first and second movable aircraft cargo handing devices each include a vehicle.

16. A movable aircraft cargo handling apparatus as set forth in claim 15, wherein:
said first movable aircraft cargo handling device forms an adapter between the aircraft and said second movable aircraft cargo handling device.

17. A movable aircraft cargo handling apparatus as set forth in claim 16, including:
at least one scissor-type mechanism for raising and lowering said loading platform.

18. A movable aircraft cargo handling apparatus as set forth in claim 17, wherein:
said first movable aircraft cargo handling device includes frame that is displaceable relative to said loading platform; and includes a transfer bridge displaceable relative to said frame, and capable of being docked adjacent the aircraft; and including
at least one power mechanism for independently raising and lowering said loading platform and said transfer bridge, whereby upper surfaces of said loading platform and said transfer bridge serve for reception of the load to be loaded or unloaded.

19. A movable aircraft cargo handling apparatus as set forth in claim 18, wherein:
said transfer bridge includes telescoping power mechanisms.

20. A movable aircraft cargo handling apparatus as set forth in claim 19, wherein:
said power mechanisms extend and retract said transfer bridge horizontally, tilt to the side with respect to the horizon, and tilt the front edge of said transfer bridge up and down with respect to the horizon.
